(19) United States
(12) Patent Application Publication
(10) Pub. No.: US 2002/0194025 A1
(43) Pub. Date: Dec. 19, 2002

(54) Novel methods for providing services and information relating to the health and well-being of adult women

(76) Inventor: Morris Notelovitz, Gainesville, FL (US)

Correspondence Address: SALIWANCHIK LLOYD & SALIWANCHIK, A PROFESSIONAL ASSOCIATION, 2421 N.W. 41ST STREET, SUITE A-1, GAINESVILLE, FL, 326066669

(21) Appl. No.: 10/167,941

(22) Filed: Jun. 10, 2002

Related U.S. Application Data
(60) Provisional application No. 60/297,348, filed on Jun. 11, 2001.

(51) Int. Cl. G06F 17/60

(52) U.S. Cl. 705/2

(57) ABSTRACT

The services provided according to the subject invention address the important medical, financial, legal and/or lifestyle issues affecting the global health and well-being of adult women worldwide. Specifically, the overall well-being of adult women is improved by providing services and information which help women prevent and/or treat medical conditions, as well as address other factors which directly affect the well-being of the adult woman. The subject invention provides a comprehensive system whereby adult women are provided with information and/or services relating to 1) medical issues and 2) quality of life care issues. In a preferred embodiment, the subject invention provides an organizational structure to facilitate providing a multiplicity of services beneficial to adult women. This organizational structure is dedicated to adult women, typically aged 16 and over, helping them to achieve optimum health and quality of life through an integrated program which provides adult women's medicine, legal, financial, and lifestyle information and services. These services can be made available to the professional and consumer public via a single web-site in sponsored neighborhood home gatherings, televised Town Hall meetings, and various print materials including but not limited to a journal.

### CROSS-REFERENCE TO A RELATED APPLICATION

This application claims the benefit of provisional patent application Serial No. 60/297,348, filed Jun. 11, 2001, which is hereby incorporated by reference herein in its entirety, including all figures, tables, and drawings.

### BACKGROUND OF INVENTION

In recent years the importance of women's health issues has been increasingly recognized among health care providers, marketers and patients. Unfortunately, however, the actual delivery of and research into women's health care has remained largely unchanged. The current approach is fragmented at best and, all too often, no meaningful care is provided.

It is well recognized that the health needs of women differ in many respects from those of men. Moreover, these health needs vary with each developmental or life stage. For women, in particular, each adult life stage poses wide ranging nutritional, medical, and social issues that significantly affect their health and well-being.

Women now live a third of their lives after menopause, causing a shift from reproductive issues to treatment and prevention of chronic illness as the central issues impacting women's health care. Although women live longer than men, they do not necessarily live better, suffering disproportionately from disability and its consequences. New socioeconomic and medical issues arise as a result of women's increased longevity. The medical conditions of greatest concern include osteoporosis, cardiovascular disease, Alzheimer's, sensory organ failure, arthritis, cancer and urinary incontinence. It is the management of these and related conditions that must form the scientific basis for the concept of an integrated approach to adult women's medicine.

Women pass through three principal adult developmental or life stages—adolescence leading to the childbearing and pre-menopausal years; the perimenopausal and menopausal stage; and the post-menopausal stage. Numerous health conditions and risks present during each of these life stages, many of which, such as cervical cancer, osteoporosis and cardiovascular disease, are initiated decades before their eventual clinical presentation.

Cardiovascular disease for example, is a major cause of death in women. It claims the lives of hundreds of thousands of women per year, most of whom are post-menopausal. Although generally not manifest until the post-menopausal stage, cardiovascular disease typically develops from early childhood and adolescence. Well-established risk factors for cardiovascular disease including abnormalities in lipid/lipoprotein, carbohydrate and homocystein metabolism are readily detectable before the manifestation of overt atherothrombotic disease, myocardial infarction, and stroke. Phytoestrogen, antioxidants, chromium, folic acid, and a regular exercise program have been shown to mitigate these risk factors. With proper information and by taking preventative measures, women can significantly reduce the likelihood of developing cardiovascular disease.

Osteoporosis is associated with the aging process and predominantly affects women. It is characterized by diminished bone density, which results in increased bone fragility and fractures of the vertebral column, hip and wrist. A spurt in the laying down of bone mineral in the spine and hip starts at puberty and reaches peak bone mass by 25 to 30 years of age. Factors influencing this process include a healthy lifestyle, exercise, and adequate calcium. Bone loss begins around age 35. This physiologic loss accelerates during menopause, which generally occurs around age 45 to 55. This loss of bone mineral can be attenuated by lifestyle and the selective use of hormone therapy. Certain vitamins and minerals can enhance calcium absorption and utilization. Thus, relatively simple measures can help prevent a disease that affects an estimated seventeen (17) million women in the United States.

In general, the risk of cancer increases with age. Breast cancer, which afflicts one in every nine women, is chief among women's concerns. Breast cancer is not a single disease. With advances in technology, it will soon be possible to identify women at increased risk of estrogen-promoted breast cancer. This involves various clinical parameters (i.e., family history of breast cancer or dense breast tissue on mammography) plus an assessment of the way in which individual women synthesize and metabolize both endogenous estrogen and prescribed estrogen. Exercise, for example, lessens the risk of breast cancer by modifying the metabolism of estrogen via a less harmful biological pathway. Thus, like cardiovascular disease and osteoporosis, the risk of developing breast cancer can be reduced through appropriate preventive measures.

Central to the success of integrating adult women's medicine and education is the education of both the health care provider and the consumer. With proper knowledge and instruction, many of these preventive measures can be readily implemented. As illustrated, although the etiology of conditions such as cardiovascular disease and osteoporosis is multi-factorial, certain dietary measures, exercise, and lifestyle modification have all been shown to provide a statistically significant benefit in reducing the risk or reducing the incidence of these diseases. However, to date, the approach to women's health issues has not fully considered the changing needs of adult women. A more individualized, sophisticated, and targeted approach is clearly necessary. Because the incidence of these conditions varies with the different life stages of a woman, there is a need for services targeted to these changing health risks at each of the life stages. For example, the type and intensity of exercise will vary with the individual's age. Also, decisions regarding treatments such as hormone therapy will vary based on the individual's needs.

As discussed above, a woman passes through three principal adult life stages. The onset of each of the various life stages can occur at different ages for different individuals and the stages suggested below for the various life stages are only approximations. The “pre-and early perimenopause” life stage, approximately ages 16 to 45, includes the childbearing or reproductive life stage, which is a period of maximum ovarian function. Major non-obstetric health concerns that arise during this life stage include dysfunctional uterine bleeding, PMS, other mood disorders, and the need for various forms of contraception.

The later perimenopause and menopause stage, approximates ages 45 to 55 years and is characterized by decreasing ovarian function. At first, menstrual cycles may be erratic before stopping. PMS-like symptoms may intensify. For 80% of all women, this stage will eventually include symptoms of menopause, such as amenorrhoea, hot flashes, night sweats, insomnia, fatigue, and mood swings. The rate of bone loss accelerates, abnormalities in the lipid profile become more apparent, thus setting the stage for the future onset of and osteoporosis and cardiovascular disease—both of which can be readily diagnosed by simple cost-effective tests.

The post-menopause stage, age 55 plus, is characterized by complete cessation of ovarian function and overtime, by an increase in the incidence of cancer (breast, endometrium, and the like), osteoporosis, myocardial infarction, and stroke. Many of these diseases can be diagnosed in the early latent phase of this stage of life.

The services provided in accordance with the subject invention are specifically designed to address common health concerns that arise during each of these life stages. Moreover, these services are designed to prevent, or reduce the risk of, conditions known to develop in later life stages. This requires the redefinition of the extent of health services provided for women. The present standard of care for menopause (menopausal medicine) is restricted largely to the symptomatic phase of the menopausal transition. Some have extended this care to women aged 35-65 years of age (climacteric medicine). The subject invention proposes the inclusion of young adults, starting from the age of 16 (integrated adult women's medicine). As preventative measures taken during early pregnancy may reduce the risk of fetal neural tube defects (i.e., by taking folic acid) and iron deficiency anemia (i.e., by prophylactic iron consumption) so it is proposed that the risk of osteoporosis, cardiovascular disease and cancer, which are generally manifest in the post-menopause life stages, may be similarly prevented or ameliorated.

At the 4^{th} International Congress on The menopause in 1984, it was noted that

Climacteric medicine is a discipline waiting to be born. In short, it can be defined as preventive medicine for women (and men) in their middle years, and it has as its basic premise consideration of the whole individual, with the objective of achieving, a healthy mind in a healthy body in a healthy environment. As such, it may be regarded as a national insurance policy. A healthy middle-age population will be a productive population; by preventing or ameliorating chronic illnesses much of the need for and cost of long-term geriatric care can be avoided. We have noted the benefit of preventive medicine in obstetrics and dentistry. Why should the climacteric be any different? It is in this context that climacteric medicine has emerged as a science and has become a societal need.

Thus, there is a multiplicity of medical conditions, which disproportionately, or exclusively, affect adult women. For many of these medical conditions modern science has identified causes and/or contributing factors. Fortunately, the occurrence and/or severity of these conditions can be significantly reduced by proper diet, exercise, and/or medication. What is needed is an efficient means for providing women with the knowledge and resources to implement the preventative and remedial measures which currently exist, or which will become available in the future. By appreciating the biology of some of the diseases noted previously, integrated adult women's medicine emphasizes a primary preventive approach for women aged 16 to 45 years; secondary intervention therapies such as hormone therapy for women aged 45 to 65 years; and targeted disease-specific treatment (i.e., lipid-lowering drugs, anti-hypertension and anti-diabetic drugs) for older women with latent or overt diseases (aged 65 years and older). Currently, it is difficult, if not impossible, for women to know where to go for comprehensive, reliable advice, information, and services to address the issues, which uniquely affect their health and well-being.

In addition to the medical conditions which uniquely affect women, there are also many non-medical daily living issues, for example, financial, legal, and lifestyle, which specifically apply to women. The financial and legal issues include, for example, career development and job placement challenges, investment opportunities and planning for retirement. Lifestyle issues include marriage counseling, child raising concerns, recreation opportunities, pharmacy discounts, and personal appearance enhancement (i.e., beauty/cosmetics.

Many of the issues and challenges which face women are interrelated; there remains a critical need in our society to address, in a comprehensive, effective and efficient manner, the multiplicity of health, societal, and economic issues which face adult women as they prepare for, enter, and pass through their later years of life.

### BRIEF SUMMARY

The services provided according to the subject invention address the important medical, financial, legal and/or lifestyle issues affecting the global health and well-being of adult women worldwide. Specifically, the overall well-being of adult women is improved by providing services and information which help women prevent and/or treat medical conditions, as well as address other factors which directly affect the well-being of the adult woman. These other factors (which are referred to herein as “quality of life care” factors) include, but are not limited to, financial, legal, and lifestyle issues.

The subject invention provides a comprehensive system whereby adult women are provided with information and/or services relating to 1) medical issues and 2) quality of life issues. Preferably, the information and services provided with respect to quality of life factors address legal, financial and lifestyle issues relevant to adult women. The legal, financial and lifestyle services and information provided according to the subject invention can include, for example, services or information relating to legal issues such as divorce, disability, and/or abuse; financial issues such as investments and/or retirement; and lifestyle issues such as education, recreation, travel, marriage counseling, career development, job placement, beauty, and cosmetics.

In a preferred embodiment, the subject invention provides an organizational structure to facilitate providing a multiplicity of services beneficial to adult women. This organizational structure, referred to herein as the Adult Women's Health Foundation (AWHF), is dedicated to adult women, typically aged 16 and over, helping them to achieve optimum health and quality of life through an integrated program which provides adult women's medicine, legal, financial, and lifestyle information and services.

### BRIEF DESCRIPTION OF DRAWINGS

FIGS. 1-9 show various aspects of the subject invention.

### DETAILED DISCLOSURE

A woman's productivity and quality of life during the adult years relate directly to her health and overall well-being. To promote good medical health and overall well-being for women, the subject invention provides a means for delivering products, services, and information to adult women. The services and information provided according to the subject invention relate to 1) medical issues and 2) quality of life care issues.

The services provided in a preferred embodiment of the subject invention include: (1) acquire, refine and distribute practical information regarding women's health to healthcare providers, women in the community and agencies that provide healthcare services; (2) train and certify appropriate healthcare providers in integrated adult women's medicine; (3) assist in the development of integrated adult women's medicine clinical practices; (4) gather and track information relating to women's health and quality of life care issues; and (5) develop and coordinate programs that provide information and resources about quality of life care factors which include, for example, daily issues, such as finance, recreation, and interpersonal communications.

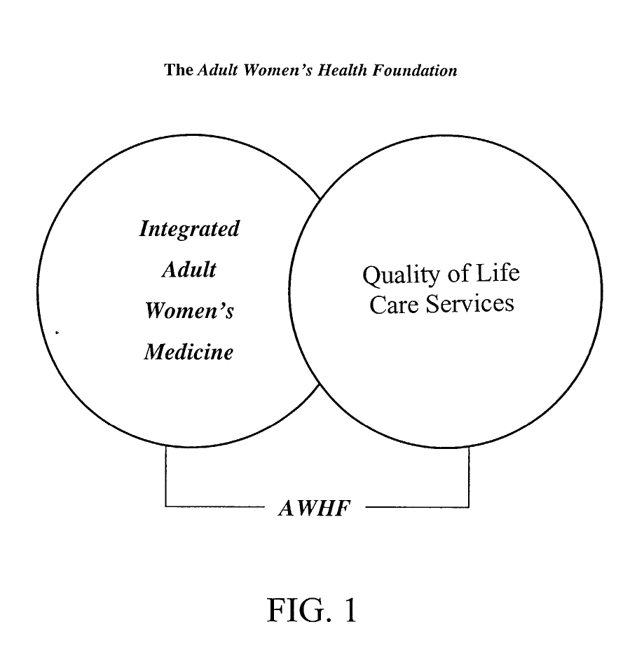

One important aspect of the subject invention concerns addressing adult women's medical issues in an efficient and comprehensive manner. To address women's health concerns effectively, it is necessary to examine the full context of a woman's life, recognizing the needs of the total woman. To do this, in one embodiment, the subject invention provides an organization dedicated to adult women's health. This organization can be referred to as the Adult Women's Health Foundation (AWHF). The AWHF, as contemplated herein, combines the principles of integrated adult women's medicine with various quality of life care issues, both of which are essential for achieving optimal well-being (FIG. 1).

It should be noted that the names and acronyms used herein (such as the “Adult Women's Health Foundation” and the “AWHF”) are used for convenience and for illustrative purposes. The subject invention is by no means limited to organizations and concepts having the particular names and acronyms exemplified herein. Rather, it is the underlying principles, ideas, systems, and organizations which form the basis of the subject invention.

The medical services provided according to the subject invention are referred to herein as Integrated Adult Women's Medicine (IAWM). As discussed above, there is increasing evidence that the pathogenesis of chronic diseases such as osteoporosis, cardiovascular disease, urinary incontinence and Alzheimer's disease commences decades before their clinical presentation and that such diseases may be effectively addressed with early delivery of preventive measures. This, of necessity, requires a fresh approach to traditional medical practice with the eventual emergence of a “new” specialty, Integrated Adult Women's Medicine. IAWM is a discipline involved with the management of the total woman from adolescence through to the care of the elderly. Excluded from this paradigm are traditional pediatrics and geriatric medicine.

One important aspect of the subject invention is the provision of healthcare, and other services, to a woman with the specific intent of improving that woman's quality of life, especially her quality of life at a later time. Thus, in accordance with the present invention, women are provided with information and/or services which help them lead more, fulfilling, happy and productive lives as they age. For example, in the area of healthcare, women are provided with diagnostic services which help them detect pathological conditions, or proclivities towards pathological conditions, as early as possible. Once such conditions are identified, remedial and/or preventative measures can be initiated.

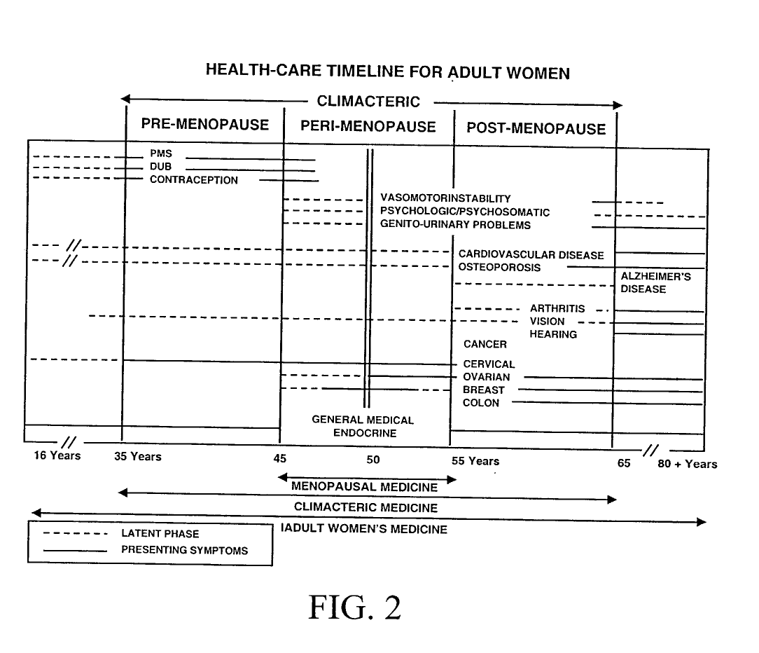

The diagnostic services which can be provided range from simple questionnaires and/or physical examinations to genetic testing. Testing to assess the likelihood of developing cancer; osteoporosis; cardiovascular disease; Alzheimer's disease; hearing or vision losses; diabetes and other autoimmune diseases; and osteoarthritis are specifically contemplated (see FIGS. 2-4).

Even for women who do not show signs of, or a proclivity towards, pathological conditions, the subject invention provides information and services designed to reduce the likelihood of developing, and/or the severity of, pathological conditions. These preventative measures include providing information about such conditions, diet and nutrition, exercise programs, and self-examination procedures.

The provision of information and/or services according to the subject invention with the intention of improving the quality of life, specifically later in a woman's life, is not limited only to women's medical issues. Thus, the quality of life care issues addressed according to the subject invention are addressed in a manner designed to enhance the likelihood of women leading productive, fulfilling lives as they age. This is accomplished by providing, for example, information and/or services which result in future benefits, and/or which can be practiced over the life of the individual. For example, the financial planning services provided according to the subject invention are designed to help women in their investments; career and retirement planning; and insurance decisions in a manner which prepare them for their financial needs as they age. Thus, the benefits of the financial decisions made at a relatively early stage of life may not be evident until later in life when the financial returns are realized.

On the other hand, the services and information provided according to the subject invention also include the teaching of skills which provide benefits now and throughout life. These skills include, but are not limited to, exercise and relaxation programs; child-raising information; continuing education; diet and nutritional information; anxiety and anger management; and exposure to information relating to a healthier and more enjoyable quality of life.

In a further aspect, the quality of life care issues addressed according to the subject invention may be issues which arise only once, or on a relatively infrequent discrete basis.

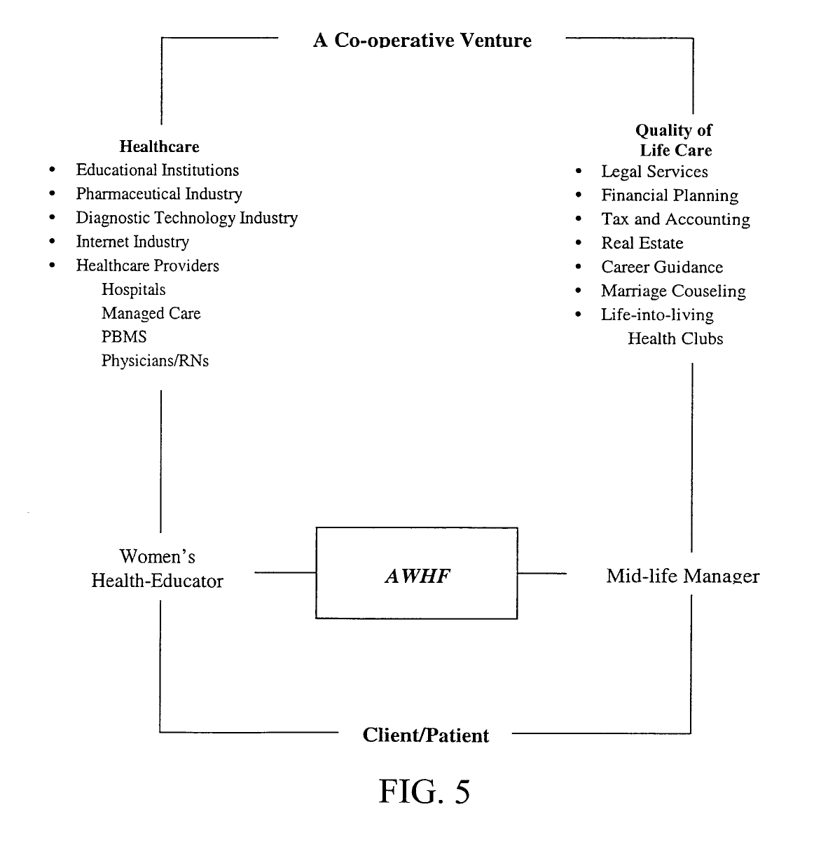

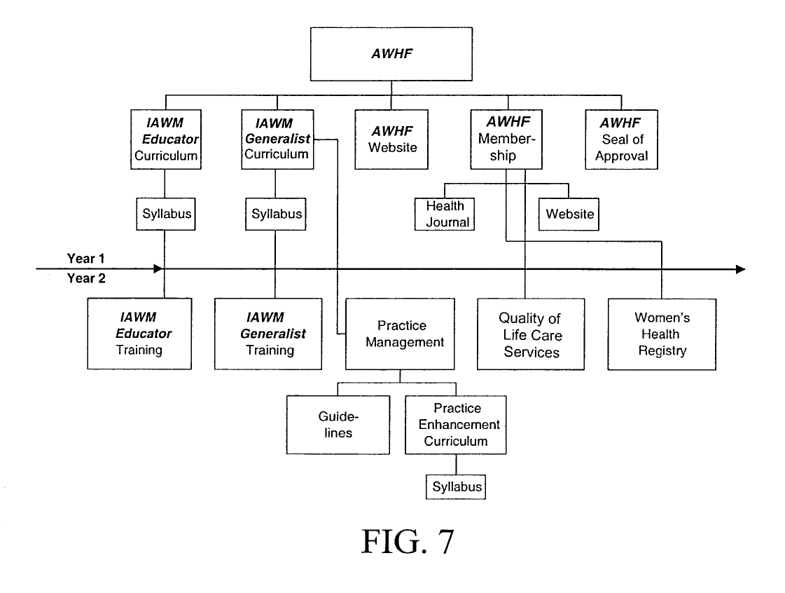

In a preferred embodiment, the services and information provided according to the subject invention can be delivered in a variety of innovative ways. For example, the delivery of integrated medicine can be facilitated by the creation of an Integrated Adult Women's Medicine (IAWM) Educator, which is described more fully below. As illustrated in FIGS. 5 through 7, the IAWM Educator functions as the central contact person between the patient and healthcare provider.

In one embodiment, the subject invention provides a person who is available to an adult woman to coordinate, and/or arrange for, the various quality of life care services which are provided according to the subject invention. In a specific embodiment, this person can be referred to as the Mid-Life Manager (MLM). See FIG. 5. The MLM can facilitate the efficient provision of services by directing the adult woman to the appropriate service provider to address any of the particular issues for which services are provided according to the subject invention. Thus, in a manner analogous to a real estate agent helping home buyers and sellers navigate through the maze of real estate issues which can arise, the MLM coordinates and facilitates the multiplicity of services provided according to the subject, thereby optimizing the efficiency with which these services are provided. In a preferred embodiment, the MLM receives specific training and is certified upon the completion of training and the demonstration of the appropriate skills and knowledge through, for example, an examination.

Also, specifically exemplified herein are customized services and organizations which address needs that are of particular interest to adult women. These customized services and organizations include an Adult Women's Health Registry; membership of AWHF; which act as valuable resources for disseminating information and delivering services; the Integrated Adult Women's Generalist (a new medical discipline) and its associated membership of certified health care providers; and an AWHFF “Seal of Approval” for services and products of interest to the quality of life-care needs of adult women. These services and organizations are described more fully below.

A unique feature of the AWHF business organization is that all services will be offered through an internet/web-based secured internet program—the Women's Health Internet Market (WHIM). This will provide consumers/client's with a “one step Internet shopping” site for advice and services relating to any or all of their healthcare and/or quality of life care needs.

An Adult Women's Health Registry. An important component in the assessment of interventions in the integrated healthcare model of the subject invention is the enrollment of female patients and members to develop a patient (member) registry. The patient (member) registry of the subject invention, with state-of-the-art security controls and firewalls, serves as an electronic patient record for both patient (member) and service provider. De-identified information contained in the database registry provides valuable information for longitudinal demographic and epidemiologic tracking, health economics outcomes analysis, development of improved treatment pathways and other valuable health and quality of life care research and services.

The registry serves additional purposes, preferably including, but not limited to: (1) a source for home testing for the primary and secondary prevention of common diseases; (2) a source for patient recruitment for clinical trials; (3) a source for data sets that include demographic and de-identified risk profiles; (4) a testing service that provides lab test results to patient and provider, aiding in patient compliance and the development/maintenance/change of treatment pathways; (5) an interactive source for patient (member) and provider of health, quality of life care, and education; and (6) the development of a genetic profile to be used for functional genomic drug development.

Customers served by the registry include pharmaceutical companies, provider organizations (including those providing quality of life care services), government agencies, major employers, nonprofit organizations and women (member) patients.

Adult Women's Health Foundation Membership (AWHFM). Membership enrollment in AWHF, a consumer, multi-level membership of AWHF organization, combining health-related services with a Quality Life Care program, can be offered to adult women. Preferably, the services are provided, but not limited to women between the ages of 35-65 years of age. Services relevant to the membership can include:

Health Information

Healthcare Provider Links via AWHF certified facilities

Legal services

Financial planning/investment

Accounting and tax advice

Real estate

Marriage counseling

Career planning and job placement

Travel

Health and fitness membership

Pharmacy discounts

Beauty and Cosmetics

Through its membership base, the AWHF can negotiate favorable contracts with its alliance partners. Enrollment in the AWHF membership program can occur via, for example, the Internet, direct mailing, or health-care/quality of life care provider. A modest annual membership fee will be required, prorated to the level of membership services requested.

In a specific embodiment, the AWHF, can be a non-profit organization, governed by a Board of Directors representing multi-disciplinary health care providers, business and finance leaders, and educators, each of whom are noted experts in their given fields. A Business Advisory Board and Scientific Council can provide worldwide multi-disciplinary advice to the Board of Directors and act as consultants to government and industry. The AWHF may elect to restrict the educational services to that of a non-profit organization and the provision of actual services, healthcare, preparation of tax returns, counseling, and the like, or to that of a for-profit divisions, provisionally named but not restricted to the Adult Women's Health Alliance.

Integrated Adult Women's Generalist. In one embodiment, the subject invention provides the Integrated Adult Women's Generalist (IAWG). This “general practitioner” for women while addressing general medical concerns, will continuously solicit the services of sub-specialists including cardiologists, gynecologists, endocrinologists, gastroenterologists, and radiologists, either through such communicative efforts as fliers, publications, telephone, and/or the Internet. Although trained in curative medicine, the IAWG's practice is heavily oriented towards preventive medicine.

The services and information of the subject invention enable a woman to lead a full and vigorous life. An important component of the services provided according to the subject invention is the establishment of preventive measures in young adulthood, thereby eliminating, or at least minimizing, the risks of chronic disabilities associated with postmenopausal women. Also, of same importance is the implementation of diagnostic services provided by the medical sub-specialists who work in conjunction with the women's medicine “general practitioners” to determine the likelihood of various diseases women face in different life stages of womanhood.

In a preferred embodiment, the information and/or services provided according to the subject invention are particularly advantageous because the comprehensive program provided by the subject invention leverages the expertise of select organizations and corporations with interests in the totality of women's health through the creation of strategic alliances (FIG. 5).

Therefore, aligning existing enterprises with requisite expertise in key areas is an important aspect of the subject invention. By leveraging alliance partners and creating enterprise-wide synergies, the implementation and development phases of the three major initiatives of the AWHF (education, research, practice development, and quality of life care services) can occur quickly and cost-effectively. As an example, alliance partners in the Women's Health Registry can preferably include one or more of the following:

Preeminent physician strategists and clinicians in women's health experienced in the concept of integrated adult women's medicine.

FDA Quality Systems Regulations Certified Organization with a scalable systems infrastructure to support telemedicine services (disease testing, communications hardware and software, counseling, medical referral); collection of data sets; clinical trial support and hotline services; and disease identification programs.

Lab provider.

Education content provider experienced with physician Continued Medical Education (CME) and patient education multimedia formats.

Women's Health Care consultant with national and international contacts at public and private levels as well as experience in clinical trials conduct and training.

Organizations providing quality of life care services—see FIG. 5.

Gathering and Tracking of Products, Services, Organizations, and Information

According to the present invention, products, services, organizations, and information are gathered and tracked for the purpose of providing women with an efficient and comprehensive site to address all medical and quality of life issues relevant to women. Products, services, organizations, and information regarding women's health and quality life care issues can be gathered via well-known means including, for example, questionnaires, advertisements from product and service providers, recommendations from service providers, and recruitment. The products, services, organizations, and information gathered may then be tracked via standard methods such as through entry of the item into a database and accounting and analysis via computerized software systems designed for tracking data. In an embodiment of the present invention, the products, services, organizations, and information gathered can be continuously assessed and analyzed to provide members with the highest quality of data.

In a preferred embodiment, the medical aspect of the subject invention focuses on three major healthcare initiatives—Education, Practice Development, and Research—to achieve an integrated adult women's medical program.

1. Education

The Education Initiative of the subject invention is multi-disciplinary and based on the integrated evaluative and prescriptive needs of healthcare providers for adult women of different ages and medical needs. The dissemination of this information can occur through a variety of media (such as print, live, and Internet) and forums (such as regional and national symposia, clinical partnerships, and certification programs). A parallel Consumer Education Initiative encompasses both education and community outreach programs in a variety of media and formats.

Although all women experience the same qualitative change in hormone biosynthesis as they mature from pre- to post-menopause, their clinical response, both symptomatically and therapeutically, varies considerably. This may be due to the heterogeneity of target hormone receptors (i.e., α and β estrogen receptors) in target tissues, the biosynthesis of hormones (i.e., the aromatization of androgens to estrogen in organs) the control of hormone bioavailability as well as other non-hormonal and age-related factors. The clinical reality is that individualized patient management is needed. The Education Initiative helps to address this need.

In a specific embodiment which emphasizes the ability to disseminate valuable information directly to adult women, small gatherings are used to provide information to adult women as well as to provide a forum for discussing issues affecting women. These gatherings may be attended by, for example, about 5 to about 30 women. In a preferred embodiment, the gathering would take place in a comfortable and informal setting such as the home of one of the women. Such gatherings can take place on a regular basis with each such gathering focusing on a particular issue, or group of related issues. Preferably, the information is provided by one or more group leaders who is trained in the relevant topic(s) and who can provide additional resources such as, for example, written materials, audio-visual materials, and information about web sites and/or other resources. The costs of these gatherings can be defrayed by, for example, one or more of the following: 1) admission or membership fees; 2) sale of relevant products; and 3) sponsorship by companies or other organizations. The sponsor(s) can be, for example, health care providers, insurance providers, health care product suppliers, financial or legal service providers, or health clubs.

The health club services can function as a very helpful and useful component of the subject invention in disseminating and providing health-related information and services. In a preferred embodiment, a health club service may function as a resource center for all kinds of health related issues and also provide a one-stop service center in which all women of different ages will have access to exercising programs, nutritional and diet programs, and massage therapy, among many other services that may be provided. The health clubs may function as a forum for the gathering mentioned above, with personal fitness trainers as group leaders to discuss relevant and related issues.

Another important component of the Education Initiative is the training of the Integrated Adult Women's Generalist (IAWG). A continuing medical education (CME) course designed to incorporate the principles and practice of integrated adult women's medicine will be developed for the primary care practitioner and interested specialists, including but not limited to gynecologists, internists, and endocrinologists. Again, the instruction will include both on-site classroom and Internet options. After completion of the course and examination, a certificate in Integrated Adult Women's Medicine Education will be issued. An annual update and periodic certification will be required.

The AWHF will also develop an IAWM Educator curriculum and certification course that will be targeted to non-physician healthcare providers (primarily nurses). The instruction will include both on-site classroom and Internet options. After completion of the course and examination, a certificate in Integrated Adult Women's Health Medicine can be issued. An annual update and periodic certification can be required.

A further aspect of the AWHF Education Initiative is the development of targeted (CME) courses. Needs assessment analyses based on practice guideline monitoring will indicate local, regional or national needs for education programs. These courses can be supported by educational grants from, for example, pharmaceutical companies.

2. Practice Development

The Practice Development Initiative consists of one or more of the following components: (1) the development, dissemination and continuous improvement of healthcare practice guidelines supported by evidenced-based medicine; (2) the development of a clinical practice infrastructure (Centers of Excellence in Integrated Adult Women's Medicine); and (3) the training and certification of health care providers and centers in integrated adult women's medicine. In a preferred embodiment, all three components are included in the Initiative.

It is not only important for physicians to learn about Integrated Adult Women's medicine but how to maximally apply this information to optimize healthcare delivery and enhance practice revenues. To this end the AWHF will develop a practice development initiative to teach physicians and other healthcare providers how to deliver integrated healthcare to women, thereby optimizing outcomes for both the patient and the physician's business. Components of this initiative can include:

A. Practice Guidelines.

The AWHF can develop and disseminate best practices guidelines supported by evidence-based medicine. A continuous quality improvement process can be used to monitor and update guidelines as interventions and technologies change.

IAWM Educators and IAWM Generalists will be able to monitor their performance against outcomes data generated from these practice guidelines, thereby being able to provide their patients with optimal health care practices. This type of information can also help physicians and physician groups negotiate more favorable contracts with managed care companies.

B. Practice Enhancement.

a) Reimbursement Training

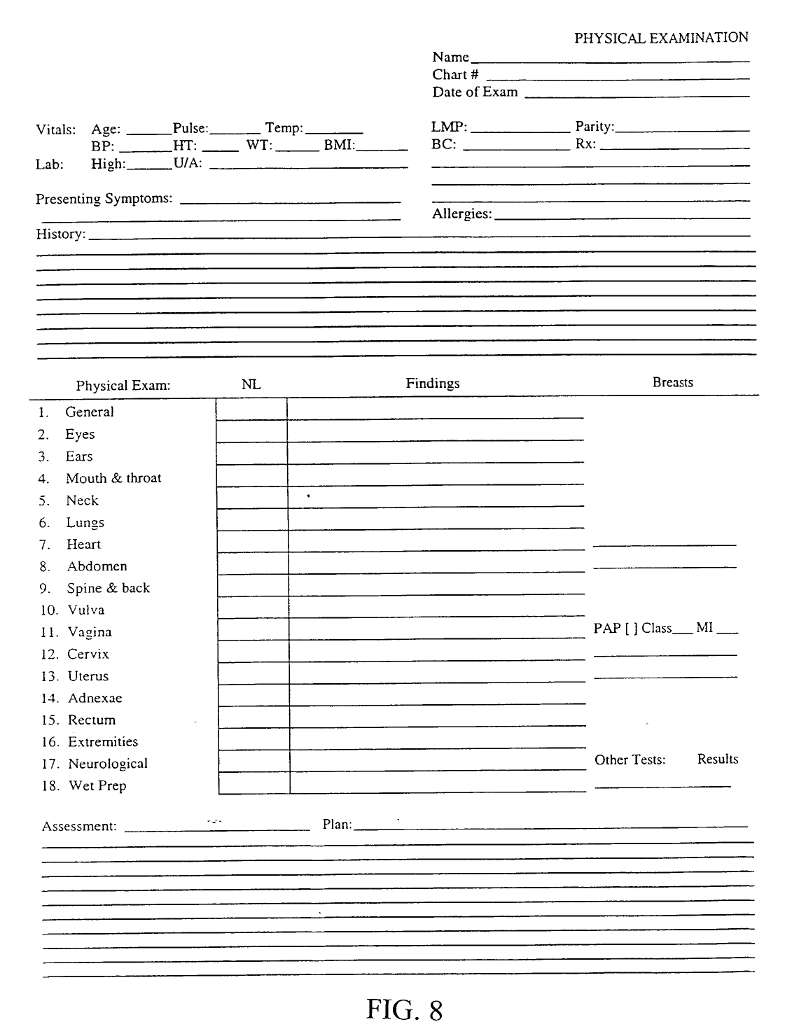

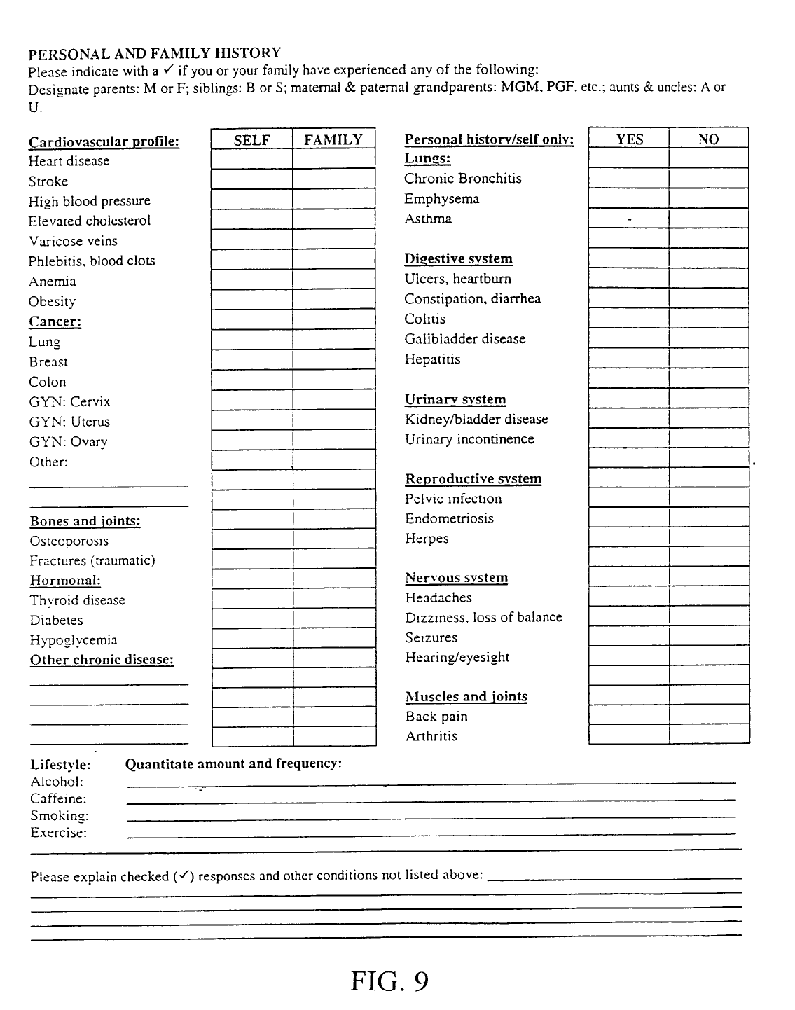

Provides information on how to employ cost-effective technology to optimize individualization of healthcare and boost practice revenues. Illustrated in FIGS. 8 and 9 are examples of the Medical History/Examination forms that can be utilized in clinical practice.

b) Practice Design Training

Provides information on how to design the clinic space to optimally deliver integrated health care and maximize return on clinic investment.

c) Clinical Research Training

Provides training on how to conduct ICH-GCP compliant research.

In a preferred embodiment, the subject invention provides a “Seal of Approval” for services relating to the health and well-being of adult women. The explosion of available health information on the Internet has resulted in information overload and difficulty for the average person to evaluate and use that information. For example, an Internet query on “women's health foundations” yielded 9556 hits while one on “women's health organizations” yielded 8605 hits. It is difficult for the user to evaluate the information presented: is the web site information correct? Is the product reliable? Are the sources involved credible? How does this information apply to a particular individual?

It is for these reasons that the subject invention provides a “Seal of Approval” for those products and services that meet a predetermined set of quality criteria. In a specific embodiment, this seal of approval is the “AWHF Seal of Approval.” By requiring alliance partners to meet specified quality standards, consumers can be assured that the products and services that carry the AWHF Seal of Approval are reliable and credible.

3. Research.

The Research Initiative of the subject invention provides opportunities for both investigator-initiated research and commercial research to be conducted at approved research sites. In a specific embodiment, the sites are approved by the AWHF. For example, the “AWHF Brain Bank” provides opportunities to researchers/commercial ventures to present/invest original concepts and ideas that the AWHF then co-develops and co-markets. As an additional aspect, a “Research Brokering Service” provides high-quality sites and administrative infrastructure support to industry for commercial clinical trial conduct.

The AWHF will also provide consulting services in all areas of Integrated Adult Women's medicine to industry, academia, health care providers and government agencies.

An AWHF Research Service will provide high-quality sites and administrative infrastructure support to industry for commercial clinical trial conduct. The AWHF Registry provides access to a longitudinal database, enabling researchers to conduct health economic and outcomes research.

AWHF clinical Research Training. Investment by pharmaceutical companies in clinical research is at an all-time high. Industry experts estimate that of the projected $51 billion dollars spent for global R&D spending in 2000, payments to investigative sites were approximate 12% or $6 billion. This represents an opportunity for many physicians to participate in the drug development process. Yet most physicians who act as principal investigators have no formal training. With increased concern among regulatory agencies about human subject protection in clinical trials, it is important for principal investigators and their staffs to be trained in clinical trial conduct.

The AWHF can provide interested IAWM Generalists with an ICH-GCP compliant training program. These highly trained principal investigators will be able to conduct both investigator-initiated trials as well as commercially sponsored clinical trails. The AWHF can provide the pharmaceutical industry with a rich source of principal investigators, interested women patient volunteers identified through the AWHF membership/organization and data from the AWHF Registry.

The services provided according to the subject invention help women achieve optimum health and quality of life. Through its three main initiatives, the AWHF anticipates the following outcomes:

Women Consumers:

1. Greater consumer awareness about women's health issues and emerging therapies.

2. Improved and individualized healthcare based on evidence based medicine.

3. More proactive involvement in personal healthcare and lifestyle events

4. Increased dialogue about health and lifestyle issues through role of IAWM Educator.

5. Greater compliance with treatment plans and therapies.

6. Enhanced quality of life through educational and other services provided by the AWHF Quality Life Care alliance partners.

Physicians and Healthcare Providers:

1. Increased knowledge about Integrated Adult Women's Medicine.

2. Enhanced provider-patient relationships.

3. Increased delivery of optimal healthcare to patients.

4. Enhanced practice revenues.

Alliance Partners:

1. Increased consumer awareness about product and service lines.

2. Market expansion and increased market share.

3. Improved customer relations.

4. Enhanced revenues.

Society:

1. Improved healthcare for one-half of the population.

2. Greater cost-savings and cost avoidance through optimal and preventive healthcare delivery.

3. Stable socio-economic environment.

Following are examples which illustrate procedures for practicing the invention. These examples should not be construed as limiting.

### EXAMPLE 1

### Health-Care Time-Line: Disease Specific

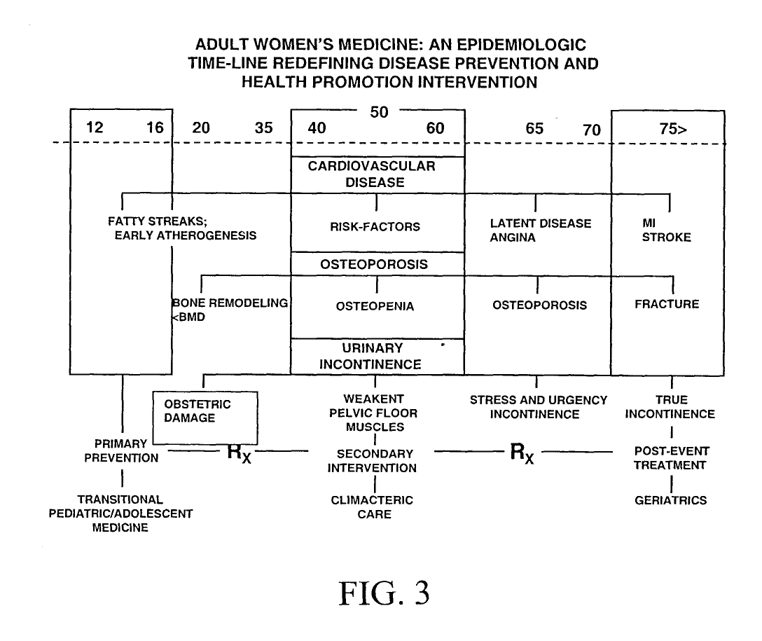

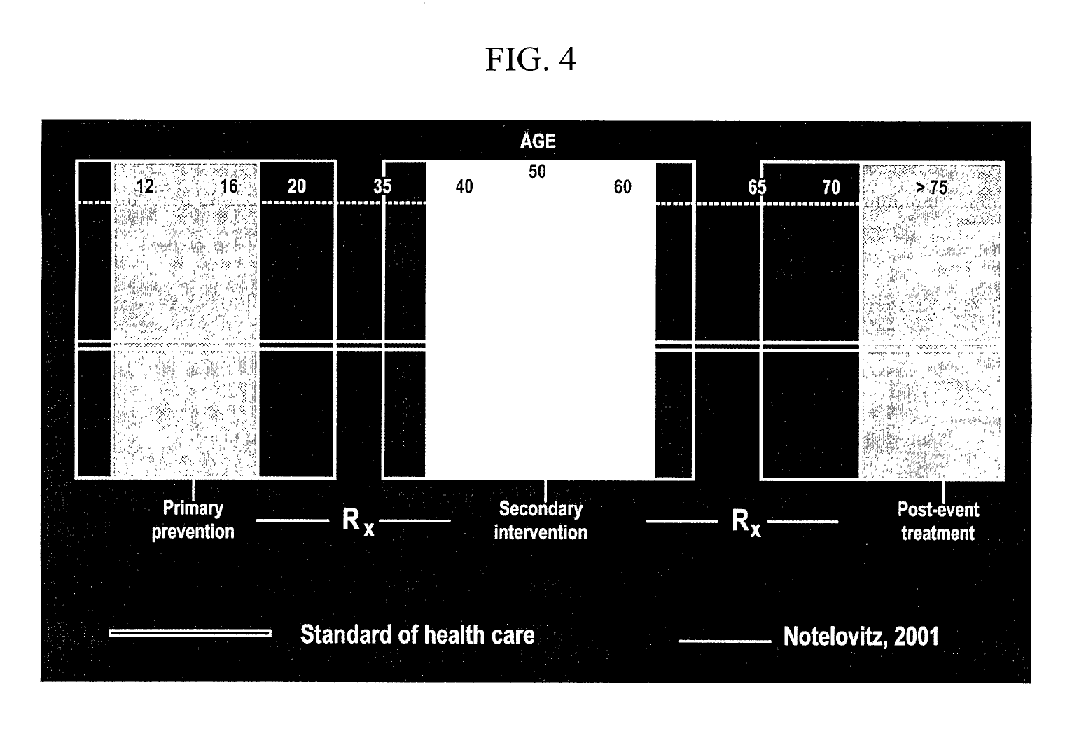

FIG. 2 summarizes the healthcare needs of adult women. FIG. 3 is a “Concept Template” that redefines the prevention/management of three common diseases in women—cardiovascular disease, osteoporosis, and urinary incontinence—according to the known pathogenesis of each condition. Based on this model, a “blank template” has been developed (FIG. 4), which can then be used to detail diagnostic and therapeutic interventions for any given condition such as osteoporosis, urinary incontinence and cardiovascular disease.

### EXAMPLE 2

### The Developing Education Programs

The foundation of both the IAWM Educator and the IAWM Generalist training programs resides in a syllabus: “Principles and Practice of Integrated Adult Women's Medicine.” Two versions can be developed: one for the non-physician audience and the other for physicians. Central to the course content for both the IAWM Educator and the IAWM Generalist is the Health Care Timeline for Adult Women (FIG. 2). By using the timeline model, the pathogenesis, prevention and treatment of common conditions and diseases affecting women are presented. Included with each topic can be current diagnostic techniques, applied pharmacodynamics, and suggested approaches to individualized evidenced-based treatment plans.

### EXAMPLE 3

### AWHF Journal and Website

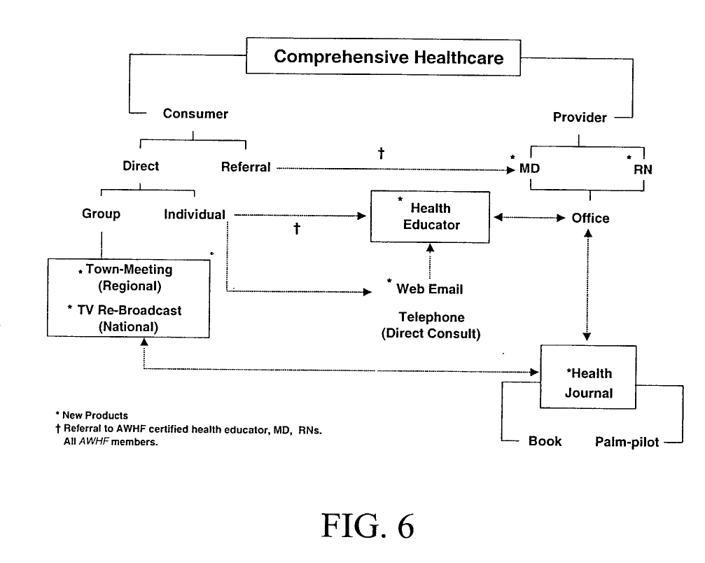

Continuing Medical Education (CME) literature suggests that maximum impact from education occurs when all audiences receive subject information simultaneously. It is for this reason that the AWHF will also educate women consumers about important health and lifestyle issues. The AWHF Journal will mirror the information presented in the IAWM professional healthcare syllabi, but in a format easily understood by the consumer. The consumer journal will enable the user to take charge of her healthcare and well-being by developing a personal health and lifestyle resource (FIG. 6).

### EXAMPLE 4

### The Town Hall Meeting: Creating IAWM Awareness and Education

The ideal educational venue would include concurrent community education about Integrated Adult Women's Medicine. The AWHF envisions a nation-wide series on Integrated Adult Women's Medicine. The AWHF envisions a nation-wide series of “Town Hall Meetings” where women in the community would be invited to learn about issues surrounding menopause and other adult women's health issues. Physicians trained in Integrated Adult Women's Medicine would conduct these interactive community programs. Immediately following the Town Hall Meeting, interested physicians in the community would attend the IAWM Generalist training program where their certification would occur. Similarly, an IAWM Educator training program would take place in that same community. Supportive local media advertising (newsprint, radio, TV) would serve to drive community awareness, participation and support. The Town Hall meeting concept will also serve as a “real life” focus group intervention and provide valuable information and marketing material for providers of healthcare and quality of life care services.

It should be understood that the examples and embodiments described herein are for illustrative purposes only and that various modifications or changes in light thereof will be suggested to persons skilled in the art and are to be included within the spirit and purview of this application and the scope of the appended claims.

1. A system for providing products, services, and information relating to women's health and quality of life care needs comprising:
a) member enrolling means for enrolling at least one woman into a member registry;
b) provider enrolling means for enrolling product and service providers into a provider registry;
c) implementation and development of alliance partners;
d) gathering and tracking means for said products, services, and information relating to women's health and quality of life care needs; and
e) development, coordination, and dissemination means for said products, services, and information relating to said women's health and quality of life care needs.

2. The system according to claim 1, wherein said women's quality of life care needs comprise one or more needs selected from the group consisting of financial issues, legal issues, real estate issues, career issues, or marriage/relationship issues.

3. The system according to claim 1, wherein said women's health care needs comprise one or more needs selected from the group consisting of women's health conditions, exercise, chronic diseases, reproductive issues, or nutritional issues.

4. The system according to claim 1, further comprising training and certification means for said service providers.

5. The system according to claim 4, wherein said training and certification means comprises
a) means for providing quality systems regulations;
b) means for providing certification regulations;
c) means for providing continuing education for said products, services, and information relating to women's health and quality of life care needs;
d) means for providing products, services, and information relating to clinical research; and
e) means for providing products, services, and information relating to practice development and enhancement.

6. The system according to claim 1, wherein said service providers are health care providers.

7. The system according to claim 1, wherein said service providers comprise educational institutions, pharmaceutical industry, diagnostic technology industry, Internet industry, financial planners, investment planners, career planners, retirement planners, or insurers.

8. The system according to claim 1, wherein said dissemination means for said services, products, and information comprises a health educator and a mid-life manager.

9. The system according to claim 1, wherein said dissemination means for said products, services, and information relating to women's health and quality of life care needs comprise one or more means selected from the group consisting of personal communication, telephone communication, television communication, periodical distribution, Internet communication, or town hall meeting.

10. The system according to claim 1, further comprising a quality assurance means for service providers.

11. A method for providing products, services, and information relating to women's health and quality of life care needs comprising:
a) enrolling at least one woman into a member registry;
b) enrolling product and service providers into a provider registry;
c) gathering and tracking said products, services, and information relating to women's health and quality of life care needs; and
d) developing, coordinating, and disseminating said products, services, and information relating to said women's health and quality of life care needs.

12. The method according to claim 11, wherein said women's quality of life care needs comprise one or more needs selected from the group consisting of financial issues, legal issues, real estate issues, career issues, or marriage/relationship issues.

13. The method according to claim 11, wherein said women's health care needs comprise one or more health care needs selected from the group consisting of women's health conditions, exercise, chronic diseases, reproductive issues, or nutritional issues.

14. The method according to claim 11, further comprising training and certifying said service providers.

15. The method according to claim 14, wherein said step of training and certifying further comprises
a. means for providing quality systems regulations;
b. means for providing certification regulations;
c. means for providing continuing education for said products, services, and information relating to said women's health and quality of life care needs;
d. means for providing products, services, and information relating to clinical research; and
e. means for providing products, services, and information relating to practice development and enhancement.

16. The method according to claim 11, wherein said service providers are health care providers.

17. The method according to claim 11, wherein said service providers comprise one or more service providers selected from the group consisting of educational institutions, pharmaceutical industry, diagnostic technology industry, Internet industry, financial planners, investment planners, career planners, retirement planners, or insurers.

18. The method according to claim 11, wherein said step of disseminating said products, services, and information relating to women's health and quality of life care needs comprises a health educator and a mid-life manager.

19. The method according to claim 11, wherein said step of disseminating said products, services, and information relating to said women's health and quality of life care needs comprise one or more forms of communication selected from the group consisting of personal communication, telephone communication, television communication, periodical distribution, Internet communication, or town hall meeting.

20. The method according to claim 11, further comprising the step of providing a quality assurance means for service providers.
